(19) United States
(12) Patent Application Publication
(10) Pub. No.: US 2026/0360646 A1
(43) Pub. Date: Nov. 12, 2026

(54) NORMALLY CLOSED POWER CONTACTOR

(71) Applicant: SAFRAN ELECTRICAL & POWER, BLAGNAC (FR)

(72) Inventors: Kévin ENOUF, MOISSY CRAMAYEL (FR); Guillaume PRIEUR, MOISSY CRAMAYEL (FR)

(21) Appl. No.: 19/139,691

(22) PCT Filed: Nov. 22, 2023
(86) PCT No.: PCT/FR2023/051838

§ 371 Date: Jun. 16, 2025

(30) Foreign Application Priority Data
Dec. 22, 2022 (FR) 2214320

(51) Int. Cl. H01H 50/30; H01H 50/22; H01H 50/32

(52) U.S. Cl. CPC H01H 50/30; H01H 50/22; H01H 50/32; H01H 2201/002

(57) ABSTRACT

A normally closed contactor includes a fixed contact and a movable contact facing each other in a housing, the movable contact being movable between a closed position and an open position. A contact pressure spring pushes the movable contact towards the fixed contact. An actuator includes a movable portion rigidly connected to the movable contact which moves it from the closed position to the open position. A return spring pushes the movable portion into its closed position. The mechanical anti-rebound device includes a first locking part rigidly connected to the housing and a second locking part opposite the first and rigidly connected to the movable portion, these locking parts being engaged in mutual locking when the movable contact is in its closed position.

### TECHNICAL FIELD OF THE INVENTION

The technical field of the invention is that of power contactors, in particular normally closed power contactors.

This invention relates to a normally closed power contactor and in particular including a mechanical debouncing device.

### TECHNOLOGICAL BACKGROUND OF THE INVENTION

A power contactor is an electrotechnical apparatus for establishing or interrupting flow of electric current. It usually comprises a fixed contact and a movable contact, which allow current flow when they are in mechanical contact, and which interrupt current flow when they are at a distance from each other.

A so-called normally closed power contactor is a contactor in which, in the state of quiescence, the fixed contact is in mechanical contact with the movable contact, which therefore allows electrical current to flow.

The field of the invention being that of normally closed power contactors, for reasons of simplification, such a normally closed power contactor will hereinafter simply be designated as a “contactor”.

FIG. 1 shows the usual geometry of such a contactor in its position of quiescence.

As is represented in FIG. 1, a contactor 1 according to prior art comprises a fixed contact 2 and a movable contact 3 facing each other and at least partially housed in a contactor chamber 4 protected by a casing 5. The contactor 1 extends along an axis X-X′. A contact pressure spring 6 pushes the movable contact 3 towards the fixed contact 2 so that in the position of quiescence of the contactor 1, the fixed contact 2 is in mechanical contact with the movable contact 3. The contactor 1 also comprises an actuator 7 extending along the axis X-X′, for example with a linear motor, generally electromagnetic, but which may also be of the pneumatic, hydraulic or other type. In FIG. 1, an actuator 7 with an electromagnetic motor is represented, including a winding 16, an external protection generally designated as body 8, a fixed part 15 attached to the body 8 and generally designated as the yoke, and a movable part 9 generally designated as the movable core. The movable part 9 moves the movable contact 3 longitudinally away from the fixed contact 2 along the axis X-X′ when the actuator 7 is powered, compressing the contact pressure spring 6 elastically and preventing current flow. Referring to FIG. 1, upon actuating the linear motor, the movable part 9 of the actuator 7 and the movable contact 3 move to the right.

According to one embodiment of prior art represented in FIG. 1, the fixed contact 2 includes a contact pad 17, while the movable contact 3 also includes a contact pad 18, these contact pads 17, 18 being designed to be in contact and allow flow of electric current when the fixed contact 2 and movable contact 3 are in mutual contact.

The displacement of the movable contact 3 by the actuator 7 is guided by a guide sub-assembly comprising a movable axle 10, a first part of which is connected to the movable contact 3 and a second part of which is integral with the movable part 9 of the actuator 7 via a connecting rod 14. The movable axle 10 of the guide sub-assembly and the movable part 9 of the actuator 7 are slidably guided along the axis X-X′, i.e. along the axis of linear displacement of the actuator 7. For the movable axle 10 this guidance is achieved by a guide ring 11 mounted in the contactor chamber 4 and attached to the casing 5, while guidance of the movable part 9 of the actuator 7 is achieved by a guide piece 12 mounted to or integral with the body 8 of the actuator 7.

In the actuator 7, the end of the movable part 9 that is not connected to the movable contact 3 is in contact with a return spring 13, also designated as “core return spring”, which is elastically compressed as the movable part 9 is displaced away from the fixed contact 2. The return spring 13 is usually located between the fixed part 15 and the movable part 9 of the actuator 7.

When power to the actuator 7 is switched off, the pressure force exerted by the contact pressure spring 6 and the return spring 13 pushes the movable contact 3 into mechanical contact with the fixed contact 2. Referring to FIG. 1, when the linear motor of actuator 7 is no longer powered, the movable part 9 of the actuator 7 and the movable contact 3 are displaced to the left.

When the movable part 9 of the actuator 7 reaches the end of stroke, the movable part 9 of the actuator 7 or a part integral with it strikes a stop, for example a fixed part of the casing 5 of the contactor 1 or a part integral with it. The movable part 9 of the actuator 7 is then a mass suspended from the return spring 13 which consequently undergoes a shock and then undergoes oscillations related to the damping coefficient of the return spring 13. These oscillations caused by the return spring 13 generate mechanical bounces of the movable contact 3 on the fixed contact 2.

Indeed, when a switch, relay, etc. is actuated, what a human perceives as a single instantaneous response to each change in the device state may in fact involve a hundred or so opening and closing actions that persist for several thousandths of a second before the contacts move into position. It is these multiple opening and closing actions that are designated as bounces.

When the power supply is switched off, the movable contacts close on the fixed contacts, but bouncing may occur via the core return spring.

These mechanical bounces can cause arc striking, which can lead to serious problems such as contact welding and erosion. These bounces are therefore likely to reduce performance of the contactor and may even lead to the contacts sticking together, rendering the contactor inoperative.

The characteristics of these bounces depend on several parameters, including the closing force, the nature of the contact material, the shape of the contacts as well as the characteristics of the electrical circuit. In power contactors, the contact switching kinematics produce vibrations in the entire system. Normally, these bounces have little or no effect on the circuit, but if the system includes a digital circuit fast enough to detect and respond to multiple bounces, it can have serious consequences.

Debouncing solutions have been developed to avoid or reduce bounces within a contactor, or to neutralise their effects.

These solutions include software-based debouncing solutions, but although they protect electrical circuits from the harmful effects of bouncing, they do nothing to protect the contactor itself, especially from damage resulting from electric arcs.

The usual hardware solution to prevent bouncing is to increase the stiffness (spring rate) of the springs, and in particular that of the core return spring. Although this solution seems simple to establish, it requires a more powerful actuator, which is therefore bulkier and heavier. These drawbacks are not acceptable for aeronautical applications where weight and volume are critical.

There is therefore a need for a hardware debouncing solution that is not based on modifying the properties of the springs in place. Advantageously, this solution has to be simple to establish, reliable, robust, inexpensive and it must not modify mechanical properties of the contactor.

The means for implementing it should be lightweight and should not increase the overall volume of the contactor equipped with it.

### SUMMARY OF THE INVENTION

The invention offers a solution to the problems discussed previously, by providing a mechanical debouncing device which, when the fixed contact and the movable contact are in the closing position, immobilises the movable part of the actuator which is integral with the movable contact with an immobilising force whose load is greater than the bounce loads in order to prevent the latter from undergoing oscillations caused by the return spring.

One embodiment of the invention relates to a normally closed power contactor comprising:
a casing,
a fixed contact and a movable contact at housed least partially in the casing and located facing each other, the movable contact being displaceable between a first closing position in which it is in mechanical contact with the fixed contact and a first opening position in which it is at a distance from the fixed contact,
a contact pressure spring exerting a push force on the movable contact towards the fixed contact,
   the normally closed power contactor being such that it comprises a mechanical debouncing device comprising:
a first locking piece integral with the casing, and
a second locking piece facing the first locking piece and integral with the movable contact; such that
   the first locking piece and the second locking piece are engaged in mutual locking by elastic deformation when the movable part is in the first position.

According to one embodiment of the invention, the normally closed power contactor comprises:
an actuator comprising a fixed part and a movable part connected to the movable contact, the movable part being displaceable between a first position and a second position, displacement of the movable part from the first position to the second position causing displacement of the movable contact from the closing position to the opening position with a displacement force provided by the actuator when powered, and
the displacement force provided by the actuator when powered is greater than the sum of the elastic deformation force of the locking pieces and the push force of the contact pressure spring.

According to another embodiment of the invention, the normally closed power contactor is such that:
the first locking piece or the second locking piece comprises a flexible and elastic blade having an elastic part and a raised part relative to the elastic part, and
the second locking piece or the first locking piece respectively comprises a recessed receiving part in which the raised part is received when the first locking piece and the second locking piece are engaged in mutual locking.

According to a further embodiment of the invention, the recessed receiving part is an annular groove.

According to one embodiment of the invention, the first locking piece or the second locking piece is a male piece having a projecting part, while the second locking piece or the first locking piece respectively is a female piece having a housing, the projecting part being inserted into the housing of the female piece when the first locking piece and the second locking piece are engaged in mutual locking.

According to another embodiment of the invention, the female piece has a flexible and elastic blade in the form of an annular-shaped crown.

According to one further embodiment of the invention, the female piece comprises several flexible and elastic blades arranged as a crown.

According to one embodiment of the invention, the immobilising force exerted by the mechanical debouncing device is greater than 5 Newton.

According to another embodiment of the invention, the normally closed power contactor is such that:
the actuator comprises a fixed part,
the power contactor comprises a return spring located between the fixed part and the movable part of the actuator, said return spring pushing the movable part into its first position with a pushing force, and
the displacement force provided by the actuator when powered is greater than the sum of the elastic deformation force of the locking pieces, the push force of the contact pressure spring and the push force of the return spring.

According to a further embodiment of the invention, the normally closed power contactor is such that:
it comprises a movable axle and a guide ring attached to the casing,
the movable contact is integral with the movable part via the movable axle, which is slidably guided by the guide ring, and
the first locking piece is attached to the guide ring or is formed as a single piece with it.

Further to the characteristics just discussed in the preceding paragraph, the normally closed power contactor according to embodiments of the invention may have one or more additional characteristics from among the following, considered individually or according to any technically possible combinations:
The first locking piece and the second locking piece are each a piece of revolution.
The return spring is located between the fixed part and the movable part of the actuator.
On its face including the recessed receiving part, the male piece has a tapered part located before the recessed receiving part, on the actuator side.
The second locking piece has a collar attached to a face of the movable part of the actuator which is directed towards the fixed and movable contacts.

By virtue of the invention, a hardware debouncing solution is provided, which is not based on modifying properties of the spring(s) in place. This hardware debouncing solution provides a kind of harpoon which tends to lock both contacts so as to prevent or limit the phenomenon of bounces.

The mechanical debouncing device supplements the lack of force of the return spring to prevent the movable part of the actuator from moving back after the shock caused by its contact with a stop.

The mechanical debouncing device according to the invention is advantageously reliable, robust and inexpensive, and is simple to implement without requiring major modifications to existing contactors or significantly altering mechanical properties of the contactor. It is lightweight and can be easily housed in the body of the contactor without increasing the overall volume thereof.

The mechanical debouncing device according to the invention generates an additional load to be supplied by the actuator upon displacing the movable contact from the closing position to the opening position, but this load is advantageously absorbed by the motor drive of the actuator because said load has to be supplied within an operating range of the actuator which is not located in its critical usable zone.

Finally, the mechanical debouncing device according to the invention advantageously provides improved cut-off performance, tests having demonstrated doubling of the cut-off capacity under short-circuit current.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a longitudinal cross-section view of a normally closed power contactor according to prior art represented in the closed state.

FIG. 2 is a longitudinal cross-section view of a normally closed power contactor according to the invention represented in the closed state.

FIG. 3 is a longitudinal cross-section view of a normally closed power contactor according to the invention represented in the open state.

FIG. 4 is a detail view of FIG. 2.

FIG. 5 is a detail view of FIG. 3.

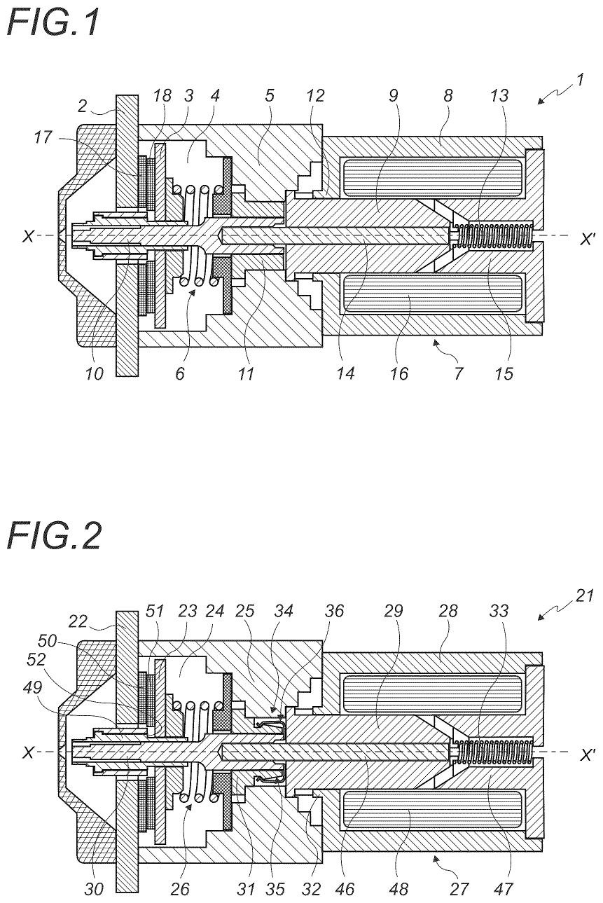

### DETAILED DESCRIPTION

Unless otherwise specified, a same element appearing in different figures has a single reference.

In this description, the term “integral” is meant to refer to a mechanical piece that is mechanically joined, directly or indirectly, to another piece, but without any clearance, so that any displacement made by one piece causes an identical displacement, without any possible clearance, for another piece that is integral with it.

Likewise, by the term “connected” it is meant a mechanical piece which is mechanically linked, directly or indirectly, to another, with possible clearance, so that any displacement made by one part may cause, but not necessarily, a displacement, with possible clearance, for another piece which is connected to it.

Finally, by “piece of revolution”, it is meant a three-dimensional piece whose general body shape can be formed by rotating a planar surface about an axis. Known examples of pieces of revolution are hollow or solid cones and cylinders. Indeed, some pieces of the normally closed power contactor according to the invention may have a generally cylindrical shape, with conical parts, grooves and/or ribs. In order to designate pieces which can have this complex shape, the term “piece of revolution” is used.

As a reminder, a normally closed power contactor will hereinafter simply be designated as a “contactor”.

Generally speaking, the contactor 21 of the invention comprises a fixed contact 22 and a movable contact 23 provided facing each other in a contactor chamber 24 protected by a casing 25. The movable contact 23 is displaceable between a closing position in which it is in mechanical contact with the fixed contact 22 and an opening position in which it is at a distance from the fixed contact 22. A contact pressure spring 26, preferably housed in the contactor chamber 24, pushes the movable contact 23 towards the fixed contact 22.

The contactor 21 of the invention extends along an axis X-X′ and also comprises an actuator 27, with a linear motor of the electromagnetic, pneumatic, hydraulic or other type. The actuator 27 comprises a fixed part 47 and a movable part 29, the movable part 29 being connected to the movable contact 23 and preferably displaced by a linear motor. The movable part 29 of the actuator 27 is movable along the axis X-X′ between a first position and a second position, corresponding to the closing position and the opening position of the fixed contact 22 and movable contact 23. Indeed, the movable part 29 is connected to the movable contact 23 so that displacement of the movable part 29 from the first position to the second position causes displacement along the axis X-X′ of the movable contact 23 from the closing position to the opening position.

The actuator 27 comprises a return spring 33 which pushes the movable part 29 into its first position. This return spring 33 is preferably located between the fixed part 47 and the movable part 29 of the actuator 27.

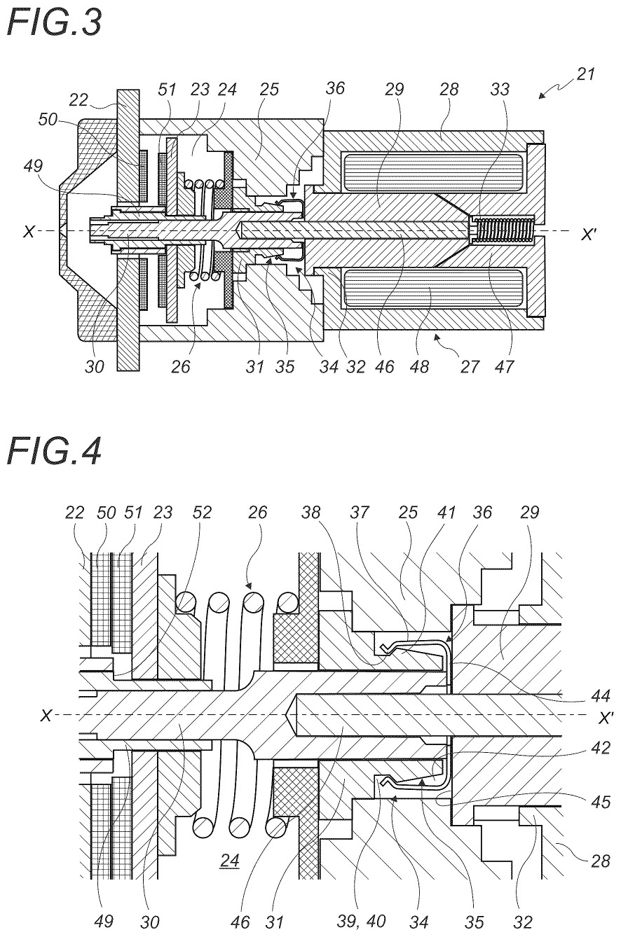

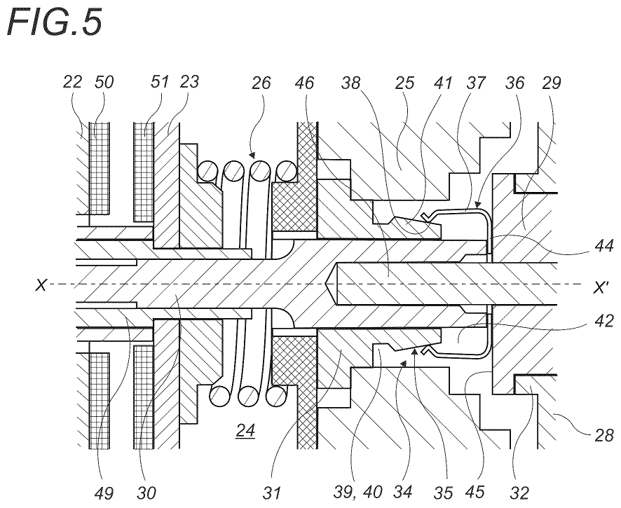

In FIGS. 2 to 5, the actuator 27 is represented by way of example in the form of an electromagnetic actuator 27, comprising a winding 48 and an external protection designated as body 28 in which the fixed part 47, the movable part 29, the winding 48 and the return spring 33 are housed.

According to one embodiment of the invention represented in FIGS. 2 to 5, the movable part 29 of the actuator 27 is secured by means of a connecting rod 46 to a movable axle 30 which moves the movable contact 23 away from the fixed contact 22 when the movable part 29 is displaced from the first position to the second position, corresponding to the opening position of the fixed contacts 22 and movable 23.

According to one preferred embodiment of the invention represented in FIGS. 2 to 5, the fixed contact 22 includes a contact pad 50, while the movable contact 23 also includes a contact pad 51, these contact pads 50, 51 being designed to be in contact and to allow flow of electric current when the fixed contact 22 and movable contact 23 are in mutual contact. The fixed contacts 22 and movable contacts 23 are, for example, made of copper, while the contact pads 50, 51 are, for example, made of silver oxide and soldered to their respective contacts.

Due to manufacturing tolerances of the actuator 27 and erosion of the contacts 23 and 22 or of the contact pads 50, 51 of said contacts 23, 22, the displacement of the movable part 29 from the first position to the second position causes a displacement of the movable contact 23 from the closing position to the opening position with some delay, after a very short stroke, for example in the order of 1 millimetre, due to a clearance between the movable axle 30 and the movable contact 23. This delay in the order of 1 millimetre corresponds to an assertion stroke of the contact pressure spring 26.

In the case where contacts 23 and 22 are each equipped with a contact pad 50, 51, this value in the order of 1 millimetre corresponds to the erosion that the contact pads 50, 51 will undergo during their life. Thus, at the start of the life of the contact pads 50, 51, the assertion stroke of the contact pressure spring 26 is in the order of 1 millimetre, whereas at the end of the life of the contact pads 50, 51, this assertion stroke tends towards 0 millimetre. Between these two values the contact pressure decreases slightly, but only minimally, the contact pressure spring 26 being selected accordingly.

To this end, according to one embodiment given by way of example and represented in FIGS. 2 to 5, the movable contact 23 is driven away from the fixed contact 22 by an intermediate piece 49 mounted integrally on the movable axle 30 when said intermediate piece 49 is driven into abutment on the movable contact 23 by connecting rod 46, via the movable axle 30 and the connecting rod 46. When the movable part 29 of the actuator 27 is displaced from the first position to the second position, the connecting rod 46, the movable axle 30 and the intermediate piece 49 are identically displaced. After a very short stroke, for example less than 1 millimetre, and during which the movable contact 23 is not displaced, a stop 52 located on the intermediate piece 49 facing the movable contact 23 comes into contact with said movable contact 23 and drives it away from the fixed contact 22, and continues to move it away from it as long as the movable part 29 of the actuator 27 is displaced from the first position towards the second position. This displacement ceases when the movable part 29 of the actuator 27 is in the second position, the movable contact 23 then being in the opening position, at a distance from the fixed contact 22.

According to one exemplary embodiment of the invention represented in FIGS. 2 to 5, the displacement along the axis X-X′ of the movable part 29 of the actuator 27 is guided by a guide piece 32, for example mounted to or as a single piece with the body 28 of the actuator 27, while the displacement along the axis X-X′ of the movable axle 30 is guided by a guide ring 31, for example attached to the casing 25.

When the movable part 29 is displaced from its second position towards its first position, this movable part 29 or a piece integral with it, for example the movable axle 30, strikes an end-of-stroke stop, which tends to make it move backwards and therefore to move the movable part 29 away from its second position. The return spring 33 then tends to push the movable part 29 back into its second end-of-stroke position, which again strikes an end-of-stroke stop, and so on in an oscillating manner, resulting in multiple opening and closing actions between the movable contact 23 and the fixed contact 22 which are designated as bounces.

In order to prevent bounces caused by the return spring 33 when the movable part 29 is displaced from its second position to its first position, the contactor 21 of the invention comprises a mechanical debouncing device 34 designed to freeze the movable masses in the closing position before these masses bounce as a result of the end-of-stroke stop and oscillate as a result of the return spring 33.

The mechanical debouncing device 34 of the invention comprises a first locking piece 35 integral with the casing 25, and a second locking piece 36 located facing the first locking piece 35 and integral with the movable part 29 of the actuator 27. When the movable part 29 is displaced from the second position to the first position, the first locking piece 35 and the second locking piece 36 are engaged in mutual locking. This locking engagement exerts an immobilising force on the second locking piece 36 greater than the tensile forces exerted by the return spring 33 so that the second locking piece 36 can no longer bounce as a result of the return spring 33 when it is locked with the first locking piece 35.

The immobilising force exerted by the mechanical debouncing device 34 is preferably greater than 5 Newton, which makes it possible to avoid the bounce phenomenon, while nevertheless allowing an actuator 27 usually used in a contactor 21 to have sufficient power to displace the movable part 29 from the first position to the second position and thus separate the first locking piece 35 and the second locking piece 36 which are engaged in mutual locking.

According to one preferred embodiment of the invention, the first locking piece 35 and the second locking piece 36 are each a piece of revolution.

According to one preferred embodiment of the invention, the first locking piece 35 or the second locking piece 36 comprises a flexible and elastic blade 37 having a raised part 38 relative to the remainder of the body of the flexible and elastic blade 37 and which is received in a recessed receiving part 39 provided in the other locking piece—i.e. the second locking piece 36 or the first locking piece 35 respectively—when the first locking piece 35 and the second locking piece 36 are engaged in mutual locking, the other locking piece 36 being the second locking piece 36 or the first locking piece 35 respectively.

According to this embodiment, it is the engagement of the raised part 38 in the recessed receiving part 39 which locks the first locking piece 35 with the second locking piece 36 in the manner of a clip. The load required to deform the flexible and elastic blade 37 is not significant compared to the closing loads caused by the contact pressure spring 26 and the return spring 33. Likewise, the elastic deformation force of the flexible and elastic blade 37 is less than the force of the actuator 27 when it is powered, so the locking force of the first locking piece 35 with the second locking piece 36 is largely exceeded by the force developed by the actuator 27.

In FIGS. 2 to 5, illustrating one preferred embodiment of the invention, it is the second locking piece 36 which comprises a flexible and elastic blade 37, while it is the first locking piece 35 which has a recessed receiving part 39.

The recessed receiving part 39 is preferably an annular groove 40. This annular groove 40 is preferably designed to receive a raised part 38 of a flexible and elastic blade 37 in the form of an annular-shaped crown or the raised part 38 of several flexible and elastic blades 37 arranged as a crown.

According to one preferred embodiment of the invention, the first locking piece 35 or the second locking piece 36 is a male piece having a projecting part 41, while the other locking piece-respectively the second locking piece 36 or the first locking piece 35-is a female piece having a housing 42, the projecting part 41 being inserted into the housing 42 of the female piece when the first locking piece 35 and the second locking piece 36 are engaged in mutual locking.

The female piece preferably comprises a flexible and elastic blade 37 in the form of an annular-shaped crown or several flexible and elastic blades 37 arranged as a crown.

In FIGS. 2 to 5, illustrating a preferred embodiment, the first locking piece 35 is a male piece, while the second locking piece 36 is a female piece.

According to one preferred embodiment of the invention, the male piece has a tapered part 43 provided on its face including the recessed receiving part 39, this tapered part 43 being located before the recessed receiving part 39, on the actuator 27 side, so as to form a guide and slide ramp for the raised part 38 of each flexible and elastic blade 37.

The second locking piece 36 preferably has a collar 44, for example substantially orthogonal to the flexible and elastic blade 37, which is attached to the face 45 of the movable part 29 of the actuator 27 which is directed towards the fixed 22 and movable 23 contacts.

According to one embodiment of the invention, the movable contact 23 is connected to the movable part 29 by means of the movable axle 30, which is slidably guided by a guide ring 31 attached to the casing 25. According to this embodiment, the first locking piece 35 is preferably attached to the guide ring 31 made as one piece with it.

Of course, the first locking piece 35 can be attached to another element of the contactor 21, even in the case where the latter includes a guide ring 31.

It will also be noted that the mechanical debouncing device 34 may include several first locking pieces 35 and second locking pieces 36. Likewise, the contactor 21 according to the invention may include several mechanical debouncing devices 34.

Finally, although the figures illustrate a single-pole contactor 21, it is obvious that the mechanical debouncing device 34 can equip a multi-pole, for example two-pole or three-pole, contactor. In these configurations, a single mechanical debouncing device 34 can be used, which retains the movable masses of all the poles, or alternatively a mechanical debouncing device 34 can be provided individually for each pole, the principle always being to counteract the forward-backward oscillation loads caused by bounces of the movable masses.

1. A normally closed power contactor comprising:
a casing,
a fixed contact and a movable contact housed at least partially in the casing and located facing each other, the movable contact being displaceable between a first closing position in which it is in mechanical contact with the fixed contact and a second opening position in which it is at a distance from the fixed contact,
a contact pressure spring exerting a push force on the movable contact towards the fixed contact,
an actuator comprising a fixed part and a movable part connected to the movable contact, the movable part being displaceable between a first position and a second position, displacement of the movable part from the first position to the second position causing displacement of the movable contact from the first closing position to the second opening position with a displacement force provided by the actuator when powered,
a return spring pushing the movable part into its first position with a pushing force,
the normally closed power contactor being characterised in that it comprises a mechanical debouncing device comprising:
a first locking piece integral with the casing, and
a second locking piece facing the first locking piece and integral with the movable contact;
the first locking piece and the second locking piece are engaged in mutual locking by elastic deformation when the movable part is in the first position, this mutual locking engagement exerting an immobilising force on the second locking piece greater than the tensile forces exerted by the return spring, the immobilising force being the locking engagement force; and
the actuator has sufficient power to displace the movable part from the first position to the second position and thereby separate the first locking piece and the second locking piece and disengage their mutual locking.

2. The normally closed power contactor according to claim 1, wherein the displacement force provided by the actuator when powered is greater than the sum of the elastic deformation force of the locking pieces, the push force of the contact pressure spring and the push force of the return spring.

3. The normally closed power contactor according to claim 1, wherein:
the first locking piece or the second locking piece comprises a flexible and elastic blade having an elastic part and a raised part relative to the elastic part, and in that
the second locking piece or the first locking piece respectively comprises a recessed receiving part in which the raised part is received when the first locking piece and the second locking piece are engaged in mutual locking.

4. The normally closed power contactor according to claim 3, wherein the recessed receiving part is an annular groove.

5. The normally closed power contactor according to claim 1, wherein the first locking piece or the second locking piece is a male piece having a projecting part, while the second locking piece or the first locking piece respectively is a female piece having a housing, the projecting part being inserted into the housing of the female piece when the first locking piece and the second locking piece are engaged in mutual locking.

6. The normally closed power contactor according to claim 5, wherein the female piece has a flexible and elastic blade in the form of an annular-shaped crown.

7. The normally closed power contactor according to claim 5, wherein the female piece comprises several flexible and elastic blades disposed as a crown.

8. The normally closed power contactor according to claim 1, wherein the immobilising force exerted by the mechanical debouncing device is greater than 5 Newton.

9. The normally closed power contactor according to claim 1, wherein the return spring is located between the fixed part and the movable part of the actuator.

10. The normally closed power contactor according to claim 1, wherein:
the normally closed power contactor comprises a movable axle and a guide ring attached to the casing,
the movable contact is integral with the movable part via the movable axle which is slidably guided by the guide ring, and
the first locking piece is attached to the guide ring or is formed as a single piece with it.
